(19) United States
(12) Patent Application Publication
(10) Pub. No.: US 2010/0282028 A1
(43) Pub. Date: Nov. 11, 2010

(54) Adjustable wrench

(76) Inventor: Ping Wen Huang, Wurih Township (TW)

Correspondence Address: Wang Law Firm, Inc., 4989 Peachtree Parkway,, Suite 200, Norcross, GA, 30092, US

(21) Appl. No.: 12/007,813

(22) Filed: Jan. 15, 2008

(51) Int. Cl. B25B 13/28; B25B 13/16

(52) U.S. Cl. 81/111; 81/165

(57) ABSTRACT

An adjustable wrench is provided for selectively producing a fixing movement or a pivotal turning movement by pressing or releasing a stop module to pivot the pivotal jaw, so that the adjustable wrench can change the width of its opening quickly, and such adjustable wrench provides an excellent operation and also reduces the operating time greatly.

### BACKGROUND OF THE INVENTION

1. Field of the Invention

The present invention relates to an adjustable wrench, and more particularly to an adjustable wrench that can change the width of an opening of the wrench quickly.

2. Description of the Related Art

In general, a traditional adjustable wrench includes a handle, a fixed jaw and a movable jaw, both movably disposed at an end of the handle, a serrated portion disposed at an internal end of the movable jaw, and a screw rod pivotally coupled to the handle and engaged with the serrated portion of the movable jaw, such that when a worm shaft is rotated, the movable jaw is driven to move accordingly.

With the aforementioned structure, if a user needs to change the size of an opening of the adjustable wrench, then the user must keep turning and adjusting the worm shaft by a thumb to move the movable jaw back and forth, and thus wasting time and efforts.

### SUMMARY OF THE INVENTION

It is a primary objective of the present invention to overcome the shortcomings of the prior art by providing an adjustable wrench for selectively producing a fixing movement or a pivotal turning movement by pressing or releasing a stop module to pivot the pivotal jaw, so that the adjustable wrench can change the width of its opening quickly, and such adjustable wrench provides an excellent operation and also reduces the operating time greatly.

To achieve the foregoing objective, the present invention provides an adjustable wrench, comprising:

a handle;

a driving head, fixed to an end of the handle, and having a position limit slide, a chamber, and a control chamber, and the chamber being interconnected with the position limit slide, and the chamber extending along a direction of its thickness and being interconnected to the outside, and the chamber interconnecting the control chamber through a through hole;

a movable jaw, with an end being a serrated portion, and the serrated portion being slid into an end in the position limit slide;

a pivotal jaw, with an end being a position limit portion, and having a pivot portion disposed proximate to the central position of the pivotal jaw, and the pivot portion being pivotally coupled to an end of the position limit slide and away from the movable jaw, such that the position limit portion is disposed in the control chamber;

a worm shaft module, installed in the chamber, and comprising a locking element, a worm shaft, and a resilient element, and the locking element being fixed to the worm shaft, and passing through the resilient element, such that an end of the resilient element is passed through a through hole of the driving head and pressed at the position limit portion of the pivotal jaw; and

a stop module, installed in the control chamber, for stopping the position limit portion of the pivotal jaw to fix the pivotal jaw.

### BRIEF DESCRIPTION OF THE DRAWINGS

FIG. 1 is a perspective view of the present invention;

FIG. 2 is an exploded view of the present invention;

FIG. 3 is a section view of a normal condition of the present invention;

FIG. 4 is a schematic view of using the present invention;

FIG. 5 is a section view of Section 4-4 as depicted in FIG. 4, showing the relation between the positions of a blocking element and a press button;

FIG. 6 is a section view of Section 6-6 as depicted in FIG. 5, showing the displacement produced by pressing a press button;

FIG. 7 is an exploded view of a second preferred embodiment of the present invention;

FIG. 8 is a schematic view of a normal condition of a second preferred embodiment of the present invention;

FIG. 9 is a schematic view of using a second preferred embodiment of the present invention;

FIG. 10 is a section view of a first lateral side of a second preferred embodiment of the present invention;

FIG. 11 is a section view of a second lateral side of a second preferred embodiment of the present invention; and

FIG. 12 is a perspective view of a press button of a second preferred embodiment of the present invention.

### DETAILED DESCRIPTION OF THE PREFERRED EMBODIMENTS

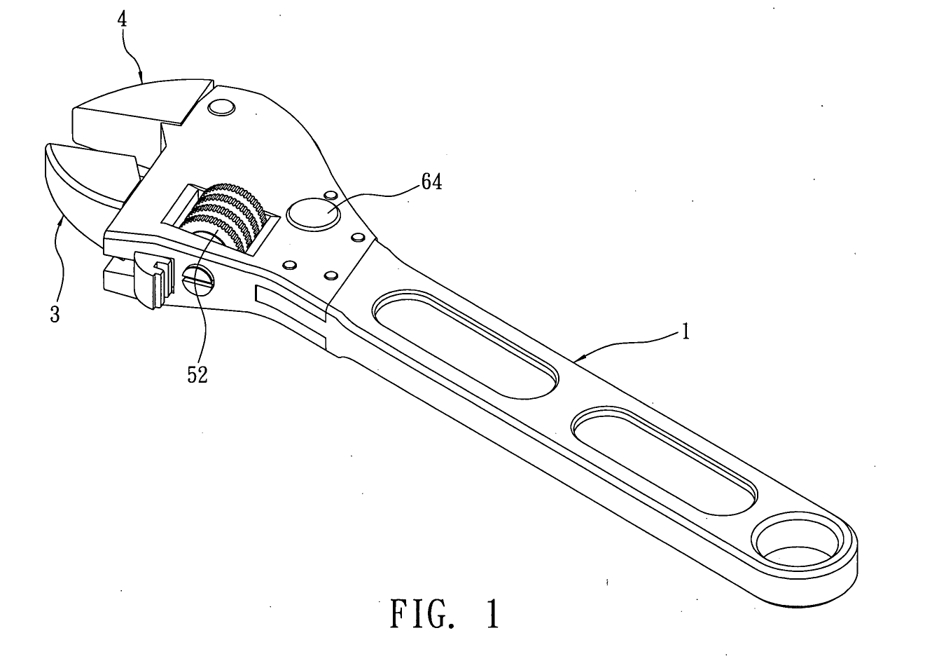

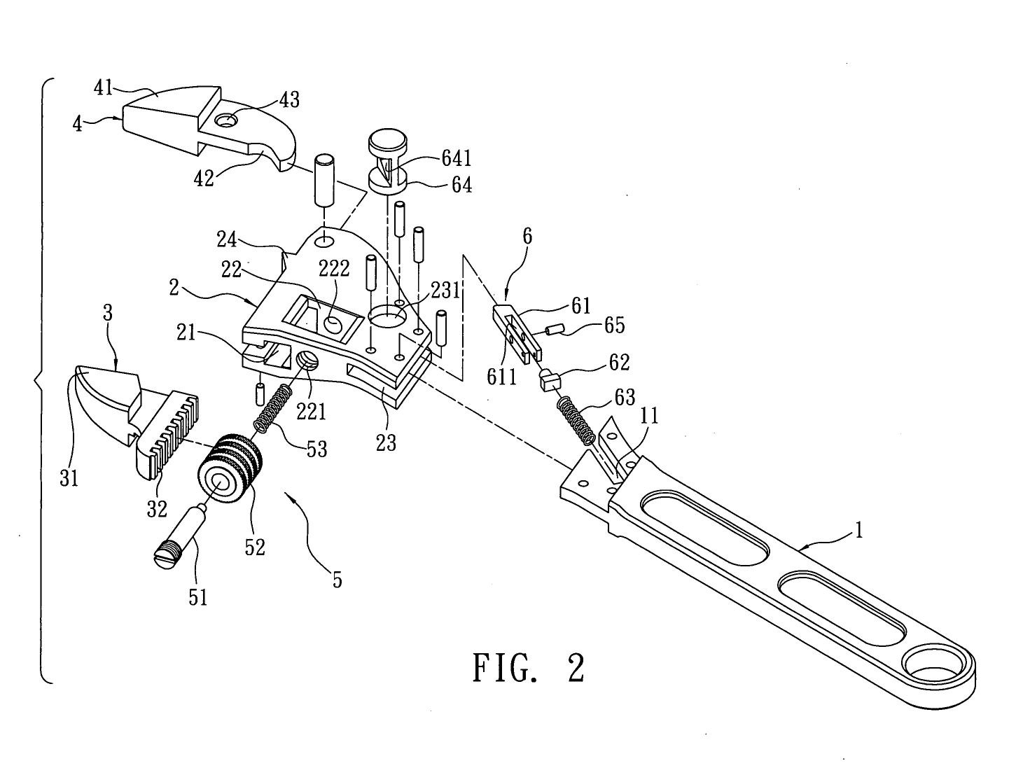

Referring to FIGS. 1 to 6 for a preferred embodiment of the present invention, the preferred embodiment is used for illustrating the invention only, but not intended to limit the scope of the present invention.

In this embodiment, an adjustable wrench comprises a handle 1, a driving head 2, a movable jaw 3, a pivotal jaw 4, a worm shaft module 5, and a stop module 6.

The handle 1 is made of aluminum, and an end of handle 1 has a guide slot 11. The driving head 2 is fixed to the handle 1 and has an end of guide slot 11, and the driving head 2 includes a position limit slide 21, a chamber 22, and a control chamber 23, and the chamber 22 is interconnected with the position limit slide 21, and the chamber 22 is extended along the direction of its thickness and interconnected to the outside, and both corresponding sides of the chamber 22 have a screw hole 221 and a through hole 222, and the through hole 222 is interconnected with the control chamber 23, and both opposite sidewalls of the control chamber 23 have a control hole 231 each, and the driving head 2 has a blocking portion 24 protruded from an end of the position limit slide 21.

The movable jaw 3 has an end which is a first working portion 31 and another end which is a serrated portion 32, and the serrated portion 32 is slidably disposed in the position limit slide 21. The pivotal jaw 4 has an end which is a second working portion 41 and another end which is a position limit portion 42, and the second working portion 41 is pressed against a blocking portion 24 of the driving head 2, and a pivot portion 43 is disposed on the pivotal jaw 4 and proximate to the central position of the pivotal jaw 4, and the pivot portion 43 is pivotally coupled to an end of the position limit slide 21 and away from the movable jaw 3, such that the position limit portion 42 is situated in the control chamber 23.

The worm shaft module 5 is installed in the chamber 22, and the worm shaft module 5 comprises a locking element 51, a worm shaft 52, and a resilient element 53 installed sequentially, wherein the locking element 51 can be passed from an end of the worm shaft 52 and protruded from another end and out of the worm shaft 52, and a protruding end of the locking element 51 is passed through the resilient element 53, and the locking element 51 is locked into a screw hole 221 of the driving head 2 to drive an end of the resilient element 53 to pass through a through hole 222 of the driving head 2 and press against on the position limit portion 42 of the pivotal jaw 4.

The stop module 6 is installed in the control chamber 23, and the stop module comprises a blocking element 61, an intermediate element 62, a resuming element 63, and a press button 64, wherein the blocking element 61 has a slide slot 611, and the middle of the press button 64 corresponds to the installation of the slide slot 611 of the blocking element and has a triangular hole 641, and a pin 65 is inserted into the slide slot 611 and passed through a triangular hole 641 of the press button 64, such that the press button 64 is limited into the slide slot 611, and the press button 64 is protruded from a control hole 231 of the control chamber 23, and an opening end of the slide slot 611 of the blocking element 61 is pressed onto the intermediate element 62, and another end of the intermediate element 62 has the resuming element 63, such that the resuming element 63 is contained and pressed into the guide slot 11 of the handle 1.

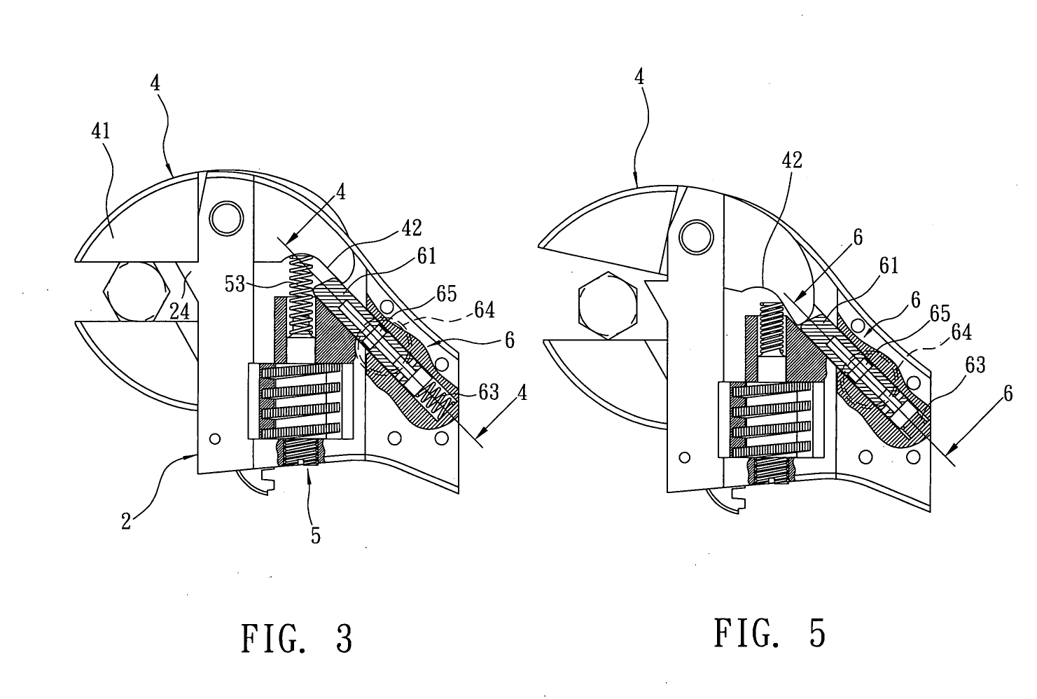

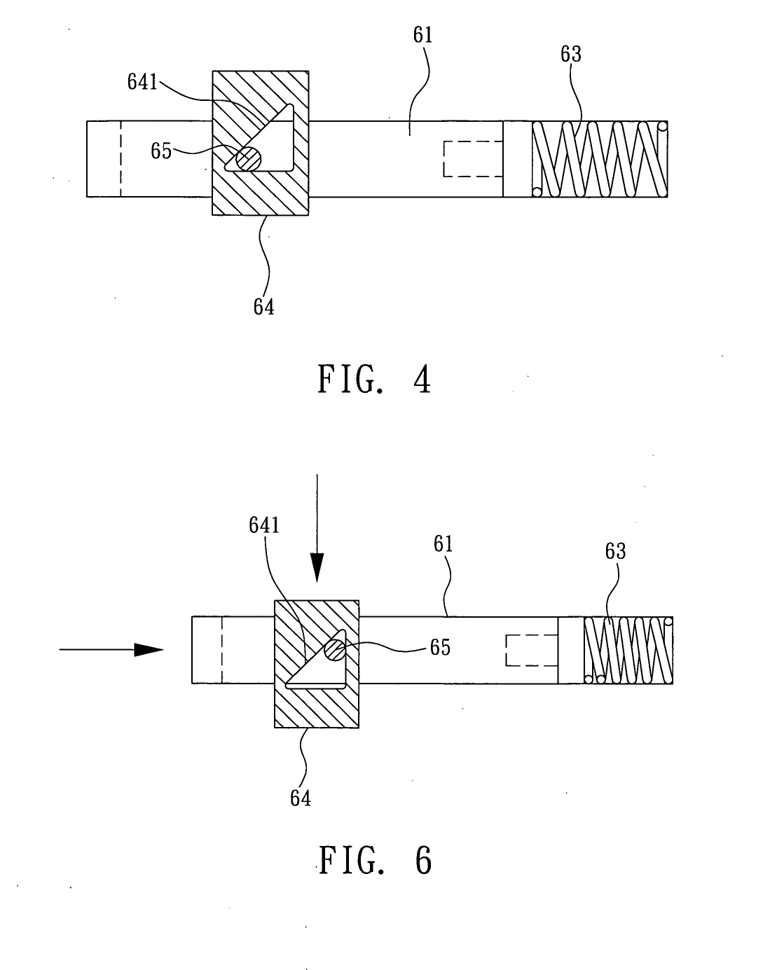

Referring to FIGS. 3 and 4, if the adjustable wrench with the aforementioned structure is used in normal conditions, the width of the opening is adjusted by securing or loosening a screw. By then, the blocking element 61 of the stop module 6 is pressed onto the position limit portion 42 of the pivotal jaw 4 by the resuming element 63, and the resilient element 53 of the worm shaft module 5 is pressed onto the position limit portion 42 of the pivotal jaw 4, such that the second working portion 41 of the pivotal jaw 4 is pressed onto the blocking portion 24 of the driving head 2, so as to fix the pivotal jaw 4 into a position for locking or loosening a screw.

Referring to FIGS. 5 and 6, if it is necessary to reset the adjustable wrench to a position being sheathed by the screw during the application, it is difficult to reset the wrench since the distance between the opening of the adjustable wrench and the screw head is too short. A user can press a press button 64 of the stop module 6, so that a triangular hole 641 in the press button 64 is moved towards another side, and a slanting edge of the triangular hole 641 is pressed and fixed to a pin 65 of the blocking element 61, and the whole blocking element 61 is shifted horizontally sideway towards the resuming element 63. As a result, he blocking element 61 is separated from the position limit portion 42 of the pivotal jaw 4. Furthermore, the position limit portion 42 of the pivotal jaw 4 is not limited by the blocking element 61, and thus an appropriate pivoting angle is provided to facilitate resetting the position of the opening of the adjustable wrench at a position for rotating a screw head.

With the structure of the pivotal jaw, the pivotal jaw is driven by a stop module for a pressing or releasing movement to produce a fixing or pivotal turning, and allow the adjustable wrench to change the width of its opening quickly.

Further, the aforementioned adjustable wrench capable of changing the width of the opening quickly provides excellent operations and reduces the operating time greatly.

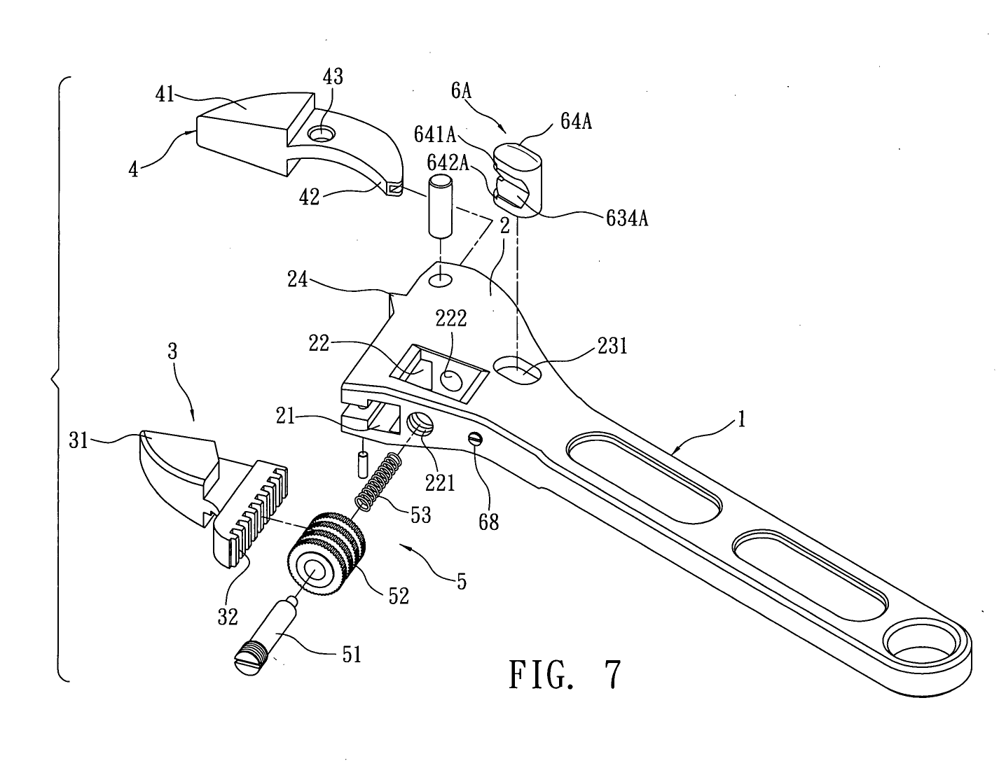

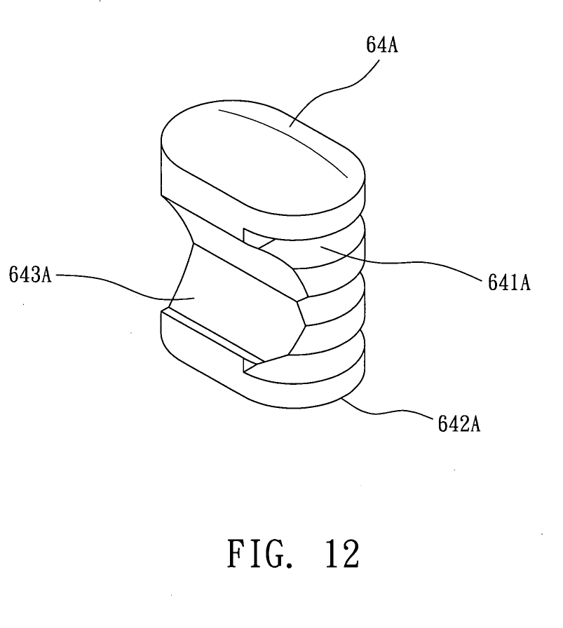

Of course, there are other embodiments of the present invention with minor modification. Referring to FIGS. 7 to 12 for a second preferred embodiment of the present invention, the stop module 6A is installed in the control chamber 23, and has a press button 64A installed in a control hole 231 that connects the driving head 2 with the control chamber 23. The difference resides on that the press button 64A has a plurality of grooves 641A for embedding the position limit portion 42 at an end of the pivotal jaw 4, and each groove 641A has a plurality of blocking portions 642A, and two corresponding slanting concave surfaces 643A, and the driving head 2 has a screw hole 222 disposed at a position corresponding to the slanting concave surface 643A, and a pin 66 is inserted into the screw hole 222 and pressed onto the slanting concave surface 643A of the press button 64A, and the pin 66 is pressed by a compression spring 67, and the compression spring 67 is pressed by a screw 68 and locked into the screw hole 222 of the driving head 2, for stopping the position limit portion 42 of the pivotal jaw 4 to fix the pivotal jaw 4.

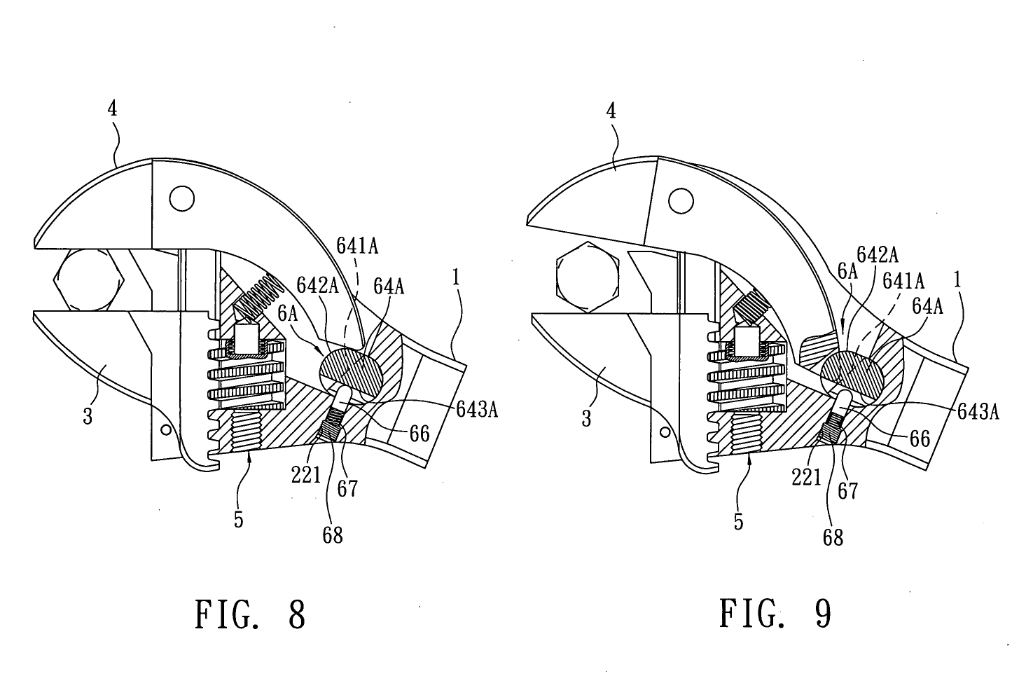

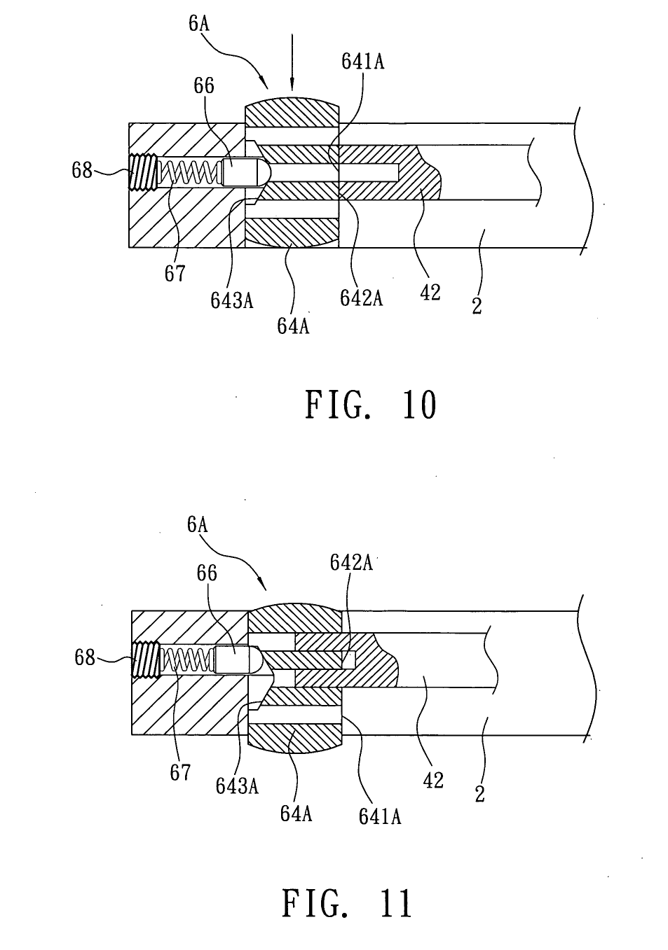

From the aforementioned structure, an end of the position limit portion 42 of the pivotal jaw 4 is pressed onto the blocking portion 642A of the press button. 64A during an application, and thus when the wrench is sheathed onto a screw head, the wrench can be rotated normally (as shown in FIGS. 8 and 10). When the wrench is turned to a predetermined range and turned backward, the press button 64A can be pressed to subside an end the position limit portion 42 of the pivotal jaw 4 into the groove 641A of the press button 64A, such that when the wrench is turned backward, the pivotal jaw 4 will move outward with respect to the movable jaw 3 as shown in FIGS. 9 and 11. The wrench can be resumed to its original position and ready for the next turn without moving the rotated screw head.

What is claimed is:

1. An adjustable wrench, comprising:
a handle;
a driving head, fixed to an end of the handle, and having a position limit slide, a chamber, and a control chamber, and the chamber being interconnected with the position limit slide, and the chamber extending along a direction of its thickness and being interconnected to the outside, and the chamber interconnecting the control chamber through a through hole;
a movable jaw, with an end being a serrated portion, and the serrated portion being slid into an end in the position limit slide;
a pivotal jaw, with an end being a position limit portion, and having a pivot portion disposed proximate to the central position of the pivotal jaw, and the pivot portion being pivotally coupled to an end of the position limit slide and away from the movable jaw, such that the position limit portion is disposed in the control chamber;
a worm shaft module, installed in the chamber, and comprising a locking element, a worm shaft, and a resilient element, and the locking element being fixed to the worm shaft, and passing through the resilient element, such that an end of the resilient element is passed through a through hole of the driving head and pressed at the position limit portion of the pivotal jaw; and
a stop module, installed in the control chamber, for stopping the position limit portion of the pivotal jaw to fix the pivotal jaw.

2. The adjustable wrench of claim 1, wherein the stop module comprises a blocking element, a resuming element, and a press button, and the blocking element includes a slide slot for passing the press button, and the resuming element is pressed at the blocking element for moving the blocking element forward or backward by pressing the press button.

3. The adjustable wrench of claim 1, wherein the handle is made of aluminum.

4. An adjustable wrench, comprising:
a handle;
a driving head, fixed to an end of the handle, and having a position limit slide, a chamber, and a control chamber, and the chamber being interconnected with the position limit slide, and the chamber extending along a direction of its thickness and being interconnected to the outside, and the chamber interconnecting the control chamber through a through hole;
a movable jaw, with an end being a serrated portion, and the serrated portion being slid into an end in the position limit slide;
a pivotal jaw, with an end being a position limit portion, and having a pivot portion disposed proximate to the central position of the pivotal jaw, and the pivot portion being pivotally coupled to an end of the position limit slide and away from the movable jaw, such that the position limit portion is disposed in the control chamber;
a worm shaft module, installed in the chamber, and comprising a locking element, a worm shaft, and a resilient element, and the locking element being fixed to the worm shaft, and passing through the resilient element, such that an end of the resilient element is passed through a through hole of the driving head and pressed at the position limit portion of the pivotal jaw; and
a stop module, installed in the control chamber, and having a press button installed into a control hole that connects the driving head with the control chamber, and the press button having a plurality of grooves sunken into the position limit portion at an end of the pivotal jaw, and each groove having a plurality of blocking portions and two corresponding slanting concave surfaces, and the driving head having a screw hole disposed at a position corresponding to the slanting concave surface, and a pin being installed into the screw hole and pressed onto the slanting concave surface of the press button, and the pin being pressed by a compression spring, and the compression spring being abutted by a screw and locked and fixed into the screw hole of the driving head.
